(19) United States
(12) Patent Application Publication
(10) Pub. No.: US 2012/0192542 A1
(43) Pub. Date: Aug. 2, 2012

(54) SYSTEM FOR CONTROLLING FUEL SUPPLY FOR A GAS TURBINE ENGINE

(75) Inventors: Rahul Jaikaran Chillar, Atlanta, GA (US); Flavien Foissey, Valdoie (FR); Sudhakar Todeti, Bangalore (IN); Kiran Vangari, Bangalore (IN); Guillaume Zaepfel, Belfort (FR); Rahul Appasaheb Warale, Rahuri (IN)

(73) Assignee: GENERAL ELECTRIC COMPANY, Schenectady, NY (US)

(21) Appl. No.: 13/015,518

(22) Filed: Jan. 27, 2011

(51) Int. Cl. F02C 3/20

(52) U.S. Cl. 60/39.463

(57) ABSTRACT

A system includes a turbine fuel controller configured to control a first supply of a first fuel to a turbine engine, a second supply of a second fuel to the turbine engine, and a transition between the first fuel and the second fuel. The turbine fuel controller includes a fuel integrity control logic configured to control a volume of the first fuel in a first fuel line to maintain a first fuel integrity while the turbine engine is operating on the second fuel rather than the first fuel.

### BACKGROUND OF THE INVENTION

The subject matter disclosed herein relates to gas turbine engines with a multi-fuel system.

In general, gas turbine engines combust a mixture of compressed air and fuel to produce hot combustion gases. Certain gas turbine engines include multi-fuel systems that use, for example, both gas and liquid fuels, where the multi-fuel system allows the transfer from one fuel to the other. Certain fuels, such as the liquid fuel, may be a backup or secondary fuel. However, liquid fuel lines generally remain full of the liquid fuel with a portion of the liquid fuel located near combustors within a gas turbine compartment. This liquid fuel over time undergoes a process of decomposition and oxidation resulting in coking. High temperatures surrounding the liquid fuel lines within the gas turbine compartment may cause or accelerate the decomposition process.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a system includes a turbine fuel controller configured to control a first supply of a first fuel to a turbine engine, a second supply of a second fuel to the turbine engine, and a transition between the first fuel and the second fuel. The turbine fuel controller includes a fuel integrity control logic configured to control a volume of the first fuel in a first fuel line to maintain a first fuel integrity while the turbine engine is operating on the second fuel rather than the first fuel.

In accordance with a second embodiment, a system includes a turbine fuel controller. The turbine fuel controller includes a fuel integrity control logic configured to maintain a first fuel integrity of a first fuel in a first fuel line while a turbine engine is not operating with the first fuel in the first fuel line. The fuel integrity control logic includes a fuel replacement cycle logic configured to cycle a volume of the first fuel in the first fuel line by draining the first fuel from the first fuel line and refilling the first fuel line with a replacement supply of the first fuel.

In accordance with a third embodiment, a system includes a turbine fuel controller. The turbine fuel controller includes a fuel integrity control logic configured to maintain a first fuel integrity of a first fuel in a first fuel line while a turbine engine is not operating with the first fuel in the first fuel line. The fuel integrity control logic includes a variable fuel fill logic configured to fill a volume of the first fuel in the first fuel line with a variable fuel flow rate, and the variable fuel flow rate decreases in response to an increase in a percentage fill of the volume of first fuel line with the first fuel.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic block diagram of an embodiment of a fuel management system for a turbine system;

FIG. 2 is a flow chart of an embodiment of a process for filling fuel lines within the fuel management system of FIG. 1;

FIG. 3 is a flow chart of an embodiment of a process for cycling a fuel to maintain fuel integrity;

FIG. 4 is a graphical representation of multiple embodiments of variable rates for filling a fuel line volume with fuel over a period of time;

FIG. 5 is a graphical representation of multiple embodiments of variable fuel flow rates over a period of time; and

FIG. 6 is a graphical representation of an embodiment of cycling a fuel within the fuel management system of FIG. 1.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems for managing the supply of fuel to a turbine engine (e.g., a gas turbine engine) with a multi-fuel system. In gas turbine engines with multi-fuel systems, one fuel (e.g., gas fuel) may be the primary fuel source used by the gas turbine engine, while another fuel (e.g., liquid fuel) may be the secondary or backup fuel source for occasional use. Embodiments of the present disclosure provide a system that includes a turbine fuel controller to maintain the integrity of the liquid fuel within the liquid fuel lines, while keeping the liquid fuel available for immediate use by the turbine engine (e.g., gas turbine engine). In some embodiments, the turbine fuel controller is configured to control the supply of multiple fuels (e.g., gas and liquid fuels) to the turbine engine and a transition between these fuels. The turbine fuel controller includes various logic to maintain the integrity of the fuel (e.g., liquid fuel). For example, the fuel integrity control logic is configured to control the volume of fuel (e.g., liquid fuel) in the fuel lines to maintain the integrity of the fuel, while the turbine engine operates on another fuel (e.g., gas fuel). More specifically, the fuel integrity control logic allows the cycling of fuel (e.g., liquid fuel) by draining the fuel from the fuel lines and refilling the fuel lines with a replacement supply of the fuel. The cycling may occur after a threshold time of operating the engine or if feedback indicates that the fuel integrity (e.g., liquid fuel integrity) is less than a threshold integrity. The fuel integrity control logic also allows the rapid filling of the fuel lines (e.g., liquid fuel lines) with a variable flow rate, where the variable fuel flow rate decreases as the volume of the fuel (e.g. liquid fuel) increases in the fuel lines. In each of the disclosed embodiments, the systems are designed to maintain the integrity of the liquid fuel (i.e., prevent coking and/or oxidation), while maintaining a ready supply of liquid fuel for the turbine engine.

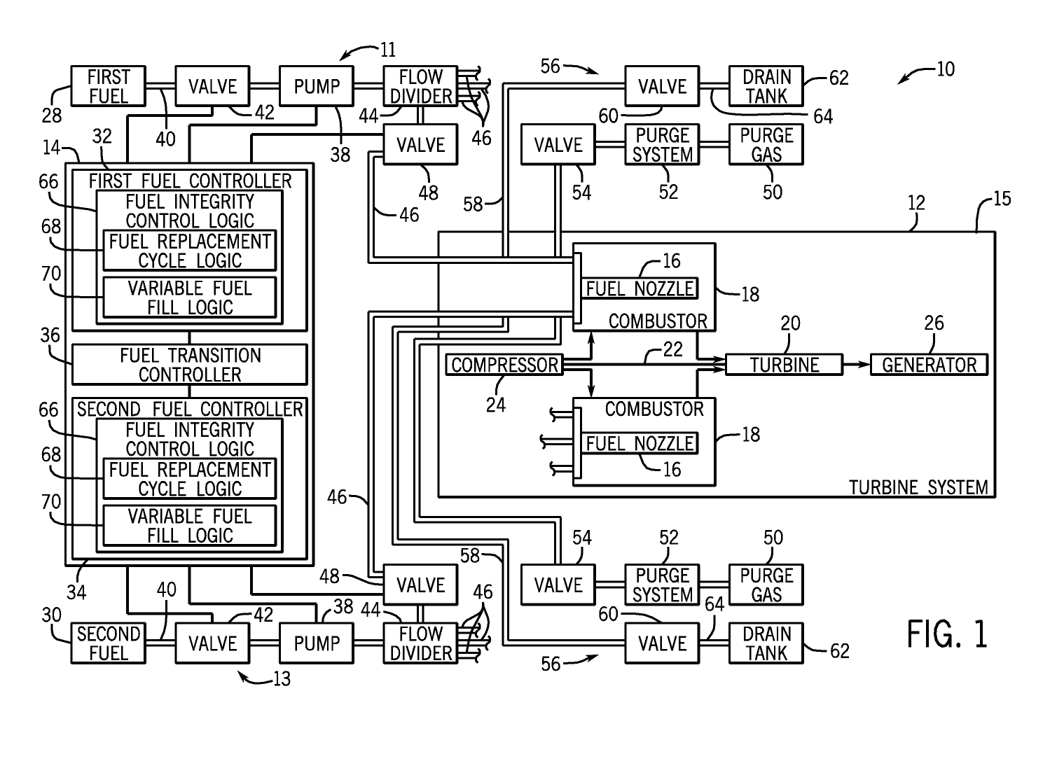

Turning now to the drawings and referring to FIG. 1, a schematic block diagram of an embodiment of a fuel management system 10 for a turbine system 12 is illustrated. As described in detail below, the disclosed fuel management system may employ a controller 14 (e.g., turbine fuel controller) to control the supply of fuel to the turbine system 12 (e.g., a turbine engine) and to manage the integrity of fuel (e.g., liquid fuel) used in the turbine system 12. The turbine system 12 may use multiple fuels, such as liquid and/or gas fuels, to drive the turbine system 12. As depicted in the turbine system 12, one or more fuel nozzles 16 (e.g., turbine fuel nozzles) intake a fuel supply (e.g., liquid and/or gas fuel), mix the fuel with air, and distribute the air-fuel mixture into a combustor 18 in a suitable ratio for optimal combustion, emissions, fuel consumption, and power output. In certain embodiments, each combustor 18 may include multiple primary fuel nozzles 16 surrounding a secondary fuel nozzle 16. The air-fuel mixture combusts in a chamber within the combustor 18, thereby creating hot pressurized exhaust gases. The combustor 18 directs the exhaust gases through a turbine 20 toward an exhaust outlet. As the exhaust gases pass through the turbine 20, the gases force turbine blades to rotate a shaft 22 along an axis of the turbine system 12. As illustrated, the shaft 22 may be connected to various components of the turbine system 12, including a compressor 24. The compressor 24 also includes blades coupled to the shaft 22. As the shaft 22 rotates, the blades within the compressor 24 also rotate, thereby compressing air from an air intake through the compressor 24 and into the fuel nozzles 16 and/or combustors 18. The shaft 22 may also be connected to a load, such as an electrical generator 26 in a power plant, for example. The load may include any suitable device capable of being powered by the rotational output of the turbine system 12.

The fuel management system 10 provides a flow of both a first fuel 28 and a second fuel 30 to the turbine system 12. In certain embodiments, the first fuel 28 includes a gas fuel and the second fuel 30 includes a liquid fuel. In other embodiments, the first and second fuels 28 and 30 may be different liquid fuels. Liquid fuels may include distillate oils, light crude, bio-liquid fuels, and other liquid fuels. Gas fuels may include natural gas and/or a hydrogen rich synthetic gas. In certain embodiments, the turbine system 12 operates on the first fuel 28 (e.g., gas fuel) as the primary fuel, and selectively operates on the second fuel 30 as a secondary fuel. The turbine fuel controller 14 is configured to control a first supply of the first fuel 28 (e.g., gas fuel) to the turbine system 12, a second supply of the second fuel 30 (e.g., liquid fuel) to the turbine system 12, and a transition between the first and second fuels 28 and 30. In particular the turbine fuel controller 14 may include a first fuel controller 32, a second fuel controller 34, and a fuel transition controller 36. The first fuel controller 32 controls the first supply of the first fuel 28 to the turbine system 12. The second fuel controller 34 controls the second supply of the second fuel 30 to the turbine system 12. The fuel transition controller 36 controls the transition or switch between the use of the first and second fuels 28 and 30 for turbine system 12.

In the illustrated embodiment, the fuel management system 10 includes a first fuel flow system 11 and a second fuel flow system 13, which include substantially the same components to enable operation with two different liquid fuels or any other combination of first and second fuels 28 and 30. Accordingly, the components of the first and second fuel flow systems 11 and 13 are depicted with the same element numbers. In other embodiments, the components of the first and second fuel flow systems 11 and 13 may differ from one another. In certain embodiments, the system 10 includes a supply of the first fuel 28 (e.g., gas fuel) in a first fuel container (e.g., gas fuel container) and a supply of the second fuel 30 (e.g., liquid fuel) in a second fuel container (e.g., liquid fuel container). The first and second fuels 28 and 30 each communicate with a pump 38 (e.g., gas and liquid fuel pumps, respectively) via an intake line 40. A valve 42 (e.g., control valve) is disposed along each intake line 40 between the first and second fuel supplies and their respective pumps 38. The control valve 42 acts as a safety valve to shutdown the flow of the first and second fuels 28 and 30 to their respective pump 38, if needed. In certain embodiments, the control valve 42 may be electrically activated. In some embodiments, a bypass line with a bypass valve may be positioned upstream of the pumps 38 to allow bypass of the pumps 38. In other embodiments, filters may be positioned about the intake lines 40 to remove impurities from the flow of the first and second fuels 28 and 30. A flow divider 44 is positioned downstream of each pump 38. The flow divider 44 divides the flow of the first and second fuels 28 and 30 according to the number of combustors 18 in the turbine system 12. For example, if the turbine system 12 includes fourteen combustors 18, then the flow divider 44 may lead to fourteen fuel lines (e.g., gas and/or liquid fuel lines) 46 for each fuel 28 and 30. However, any number of fuel lines 46 may be used herein. Each fuel line 46 in turn may split into a primary nozzle fuel line and a secondary nozzle fuel line. A stop valve may be used to separate fuel from primary nozzle fuel lines going to secondary nozzle fuel lines. Thus, for embodiments with fourteen combustors 18, twenty-eight fuel lines 46 may be used to provide the flow of the first fuel 28 to the fuel nozzles 16 and twenty-eight fuel lines 46 may be used to provide the flow the second fuel 30 to the fuel nozzles 16.

The first and second fuel flow systems 11 and 13 also include a valve 48 disposed along each fuel line 46. For example, each of the fuel lines 46 includes a valve 48 (e.g., a check valve) located downstream of, but near, the flow divider 44. The check valve 48 blocks an upstream flow of hot combustion gases and/or purge gas 50 into the fuel lines 46 when the combustors 18 switch from the flow of the first fuel 28 (e.g., gas fuel) to the flow of the second fuel 30 (e.g., liquid fuel), or vice versa. The first and second fuel flow systems 11 and 13 also include a purge system 52 (e.g., a gas purge system) and a drain system 56. The purge system 52 is in communication with each fuel line 46 just upstream of the fuel nozzle intakes. Valves 54 are disposed between the purge system 52 and each fuel line 46. The purge system 52 is in communication with a supply of purge gas 50. A flow of the purge gas 50 enters each fuel line 46 near the fuel nozzle intakes via each valve 54 to force flow of the first and/or second fuels 28 and 30 within the fuel nozzles 16 into the combustor 18 and the drainage of the first and/or second fuels 28 and 30 from the fuel lines 46 near the operating region of the turbine system 12. The drain system 56 includes a drain line 58 coupled to each fuel line 46 downstream of each check valve 48. The drain lines 58 may include primary and secondary drain lines for the primary and secondary fuel nozzle lines 46, respectively. The drain line 58 in turn leads to a valve 60 (e.g., drain valve). The fuel nozzle 16 is located above the drain valve 60. In other words, the fuel nozzle 16 is located at the highest point of a downward slope from the fuel nozzle 16 to the drain valve 60. The routing of fuel lines 46 ensures a continuous downward slope from the fuel nozzle 16 to the valve 60. In certain embodiments, a distance between the fuel nozzle 16 and the drain valve 60 may be at least approximately 20 meters.

The drain valve 60 may include multiple ports (e.g., multiport or shear valve) for each drain line 58 (e.g., primary and secondary drain lines). For example, the drain valve 60 may include fourteen ports. The drain valve 60 may open and close each drain line 58 as desired. Alternatively, multiple one port drain valves 60 may be used for each drain line 58, where each drain line 58 includes a separate drain valve 60. In embodiments with the multiple port drain valve 60, a merged drain line 64 (e.g., primary and secondary merged drain lines) is positioned downstream of the drain valve 60. The drain line 64 communicates with a purge skid. The drain line 64 includes an orifice to control or regulate the flow of the drained first and/or second fuels 28 and 30. The orifice may be sized according to the desired flow rate therethrough.

The purge skid may include a drain tank 62 as well as integrated instrumentation to monitor and regulate the purging of the first and/or second fuels 28 and 30. In certain embodiments, the purge skid may include at least two drain tanks 62. For example, the purge skid may include drain tanks 62 for both primary drain lines 64 connected to the primary fuel nozzle fuel lines 46 and secondary drain lines 64 connected to the secondary nozzle fuel lines 46. In certain embodiments, all drain lines 64 may drain into a single tank 62. The drain tank 62 may have a predetermined volume and any desired size or shape. The drain tank 62 may be pressurized so as to limit the discharge rate and quantity of the flow of the first and second fuels 28 and 30 (e.g., gas and liquid fuels, respectively). The drain tank 62 also may have a level switch therein so as to control the discharge quantity and rate. In particular, the level switch may include a high limit switch to provide an indication and alert when a level of the first and second fuels 28 and 30 in their respective tanks 62 reaches a maximum level set by the limit switch. The level switch may also include a low limit switch to provide an indication that the tank 62 has been drained and the tank 62 is ready to start a purge sequence. Each drain tank 62 further may include a level transmitter to provide the level of the first and second fuels 28 in their respective tank 62. In certain embodiments, the level transmitter may provide a feedback signal to the drain valve 60 to close upon reaching a predetermined fuel level in the tank 62. The level transmitter may also be coupled to a visual level indicator that allows a visualization of the level of the first and second fuels 30 within their respective tanks 62. Together, the level transmitter and the limit switches provide redundancy for system safety and reliability. Additionally, the drain tank 62 may be coupled to a vent valve. The vent valve may be opened to depressurize each tank 62 and help in the draining of the first fuel 28 and second fuels 30. The vent valve may be a manual valve including a closed limit switch. The drain tank 62 may be positioned apart from a turbine compartment 15 of the turbine system 10 to avoid heat therein. In certain embodiments, the drain tank 62 may be in communication with the fuel tanks, the fuel lines 46, or otherwise so as to return the flow of the first and second fuels 28 and 30.

The pump 38 is turned off and various control valves shut when the combustors 120 switch from the first fuel 28 to the second fuel 30. The valve 54 (e.g., purge gas valve) is then opened and a flow of the purge gas 50 (e.g., purge air) pushes any residual flow of first and/or second fuels 28 into the nozzle intakes to be burned in the combustor 18. Then, the drain valve 60 is opened such that the first fuel 28 (e.g., gas fuel) can be deleted as gas fuel cannot be drained under gravity and/or second fuel 30 (e.g., liquid fuel) within the fuel lines 46 flows under the force of gravity (due to the downward slope from the fuel nozzles 16 to the valves 60) and with the aid of the purge gas 50 into the drain tank 62. The discharge rate of the flow of the first and/or second fuels 28 and 30 may be limited by the size of the orifices about the drain line 64 as well as by the pressure within the drain tank 62.

The purge gas 50 may be controlled in a manner that initially flows at a low rate to push the first fuel 28 and/or second fuel 30 slowly into the combustor 18, thereby reducing the possibility of any power surges in the turbine system 12. After an initial purge, the flow rate may be increased to purge the residual first and/or second fuels 28 and 30 from the fuel lines 46. Purging the fuel lines 46 may not be a continuous operation. For example, the drain valve 60 may be sequenced to discharge any residual first and/or second fuels 28 and 30 from the hotter sections of the turbine compartment 15, followed by the cooler sections of the turbine compartment 25. However, the purging of the nozzle intakes generally may be continuous. The use of the purge system 52 and drain system 56 allows the fuel management system 10 to remove most of the flow of first and/or second fuels 28 and 30 away from the turbine compartment 15 so as to lessen the possibility of first fuel and/or second fuel decomposition and undesired consequences that may result therefrom.

In certain embodiments, the arrangement of the fuel management system 10 may vary. For example, in one arrangement, the system 10 may exclude multiport valves. Instead, each drain line 58 may include an orifice, where the orifices create enough restriction to control flow. In addition, the system 10 may include stop valves to isolate the purge system 52 from the rest of the system 10. Further, the drain tank 62 may be used solely to collect the purged first and/or second fuels 28 and 30. In other words, the first and/or second fuels 28 and 30 are not resupplied to the system 10. In this arrangement, the drain tank 62 may include a level meter and purge time is determined by a volume of the purged first and/or second fuels 28 and 30 collected in the tank 62.

In another arrangement, the fuel management system 10 includes a multiport valve (e.g., valve 60) for primary and secondary drain lines 58. In certain embodiments, a shear valve or a check valve may be used instead of the multiport valve. The multiport valve combines the purged first fuel 28 from the multiple primary and secondary fuel nozzle lines 46 into the primary and secondary merged drain line 64, respectively. The system 10 may include control valves downstream of the multiport valves to control the flow of the purged first and/or second fuels 28 and 30. Alternatively, flow regulators, instead of control valves, may located downstream of the multiport valves. The flow regulators would allow a constant outlet flow of the purged first and/or second fuels 28 and 30 regardless of downstream pressure. In certain embodiments, individual flow regulators may be used for each primary and secondary drain line 58. In addition, an orifice may be located downstream of the control valves or flow regulators to create backpressure in the system 10. The purged first and/or second fuels 28 and 30 may be collected in drain tanks 62, but not resupplied to the system 10. In this arrangement, purge time is based on the totalizing flow from either the control valves or the flow regulators.

As mentioned above, the fuel management system 10 includes the turbine fuel controller 14 to control the supply of the first and second fuels 28 and 30 to the turbine system 12 and to control the transition between the first and second fuels 28 and 30. The turbine fuel controller 14 is connected to the valves 42, 48, 54, and 60, pumps 38, instrumentation located on the purge skid, and other components of the fuel management system 10 to regulate the supply of the first and second fuels 28 and 30. In addition, the turbine fuel controller 14 is responsive to feedback from transducers located throughout the system 10 and the turbine system 12. For example, feedback may be received from level transmitters of the drain tanks 62 as to the level of the first and second fuels 28 and 30 in their respective drain tanks 62.

In certain embodiments, the first and second fuel flow systems 11 and 13 may both include drain systems 56 and purge systems 60. In other embodiments, fuel flow systems 11 and 13 that include liquid fuel circuits may include these features.

The turbine fuel controller 14 may act as a “smart” fuel controller that includes various logic that is responsive to the feedback from the system 10 and the turbine system 12. For example, the turbine fuel controller 14 includes the first fuel controller 32 that includes a fuel integrity control logic 66 configured to control a volume of the first fuel 28 (e.g., gas fuel) in the first fuel line 46 (e.g., gas fuel line) to maintain a first fuel integrity (e.g., gas fuel integrity), while the turbine system 12 is operating on the second fuel 30 (e.g., liquid fuel) rather than the first fuel 28. For example, while the turbine system 12 is not operating with the second fuel 30 in the second fuel line 46, the fuel integrity control logic 66 is configured to maintain the second fuel integrity of the second fuel 30 in the second fuel line 46 (e.g., prevent the decomposition of liquid fuel, particularly, due to the heat near the turbine compartment 25). In particular, the fuel integrity control logic 66 is configured to control the volume of the second fuel 30 in a first portion of the second fuel line 46 in an operating region of the turbine system 12 leading to the turbine fuel nozzle 16. Heat in the operating region of the turbine system 12 may cause coking and/or oxidation of the volume of the second fuel 30 to decrease the second fuel integrity of the second fuel 30. The first portion of the second fuel line 46 includes at least five meters of the second fuel line 46 nearest and leading to the turbine fuel nozzle 16. In other embodiments, the fuel integrity control logic 66 is configured to control the volume of the second fuel 30 in a portion of the second fuel line 46 extending from the turbine fuel nozzle 16 to the valve 60.

The fuel integrity control logic 66 includes a fuel replacement cycle logic 68 and a variable fuel fill logic 70. The fuel replacement cycle logic 68 is configured to cycle the volume of the second fuel 30 (e.g., liquid fuel) in the second fuel line 46 by draining the second fuel 30 from the second fuel line 46 and refilling the second fuel line 46 with a replacement supply of the second fuel 30. In particular, the fuel replacement cycle logic 68 is configured to cycle the volume of the second fuel 30 after a threshold time of operating the turbine system 12. Also, the fuel replacement cycle logic 68 is configured to cycle the volume of the second fuel 30 if feedback indicates that the second fuel integrity is less than a threshold integrity. In other words, the feedback may indicate the coking and/or oxidation of the volume of the second fuel 30. Further, the fuel replacement cycle logic 68 is configured to purge the second fuel line 46 with a purge gas 50, using the purge system 52 as described above, to force drainage of the volume of the second fuel 30 from the second fuel line 46. Indeed, in certain embodiments, the fuel integrity control logic 66 is configured to purge the first portion of the second fuel line 46 with the purge gas 50 until a request is received for the second fuel 30.

The variable fuel fill logic 70 is configured to fill the volume of the second fuel 30 in the second fuel line 46 with a variable fuel flow rate. In certain embodiments, the filling occurs after receipt of a request for the second fuel 30. The variable flow rate may include a first flow rate (e.g., of liquid fuel) followed by a second fuel flow rate (e.g., of liquid fuel), where the first fuel flow rate is greater than the second fuel flow rate. The variable flow rate may decrease in response to an increase in a percentage fill of the volume of the second fuel line 46 with the second fuel 30. The variable fuel fill logic 70 is also configured to fill the second fuel line 46 with the first fuel rate until the second fuel 30 fills a first threshold percentage of the volume in the second fuel line 46. In addition, the variable fuel fill logic 70 is configured to fill the second fuel line 46 with the second fuel 30 at the second fuel flow rate until the second fuel 30 fills a second threshold percentage of the volume in the second fuel line 46. As discussed in greater detail below, the variable fuel flow rate may include a plurality of steps of different constant fuel flow rates including the first and second fuel flow rates. In some embodiments, the variable fuel flow rate includes a linearly decreasing fuel flow rate. In other embodiments, the variable fuel flow rate includes a curvilinear fuel flow rate. The above embodiments of the turbine fuel controller 14 and the fuel management system 10 maintain the integrity of the second fuel 30 (e.g., liquid fuel) within the second fuel lines 46 (e.g., liquid fuel lines), while keeping the second 30 available for immediate use by the turbine system 12.

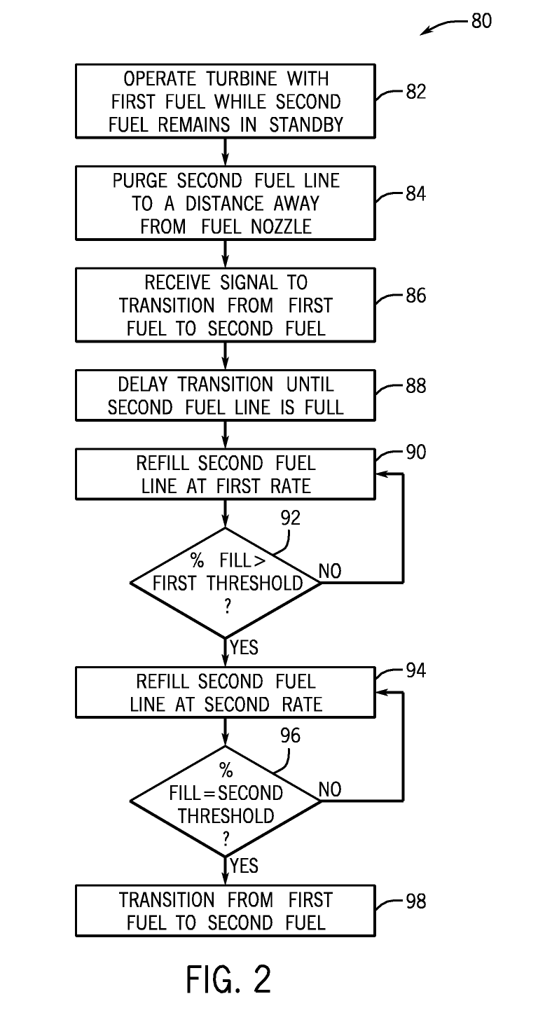

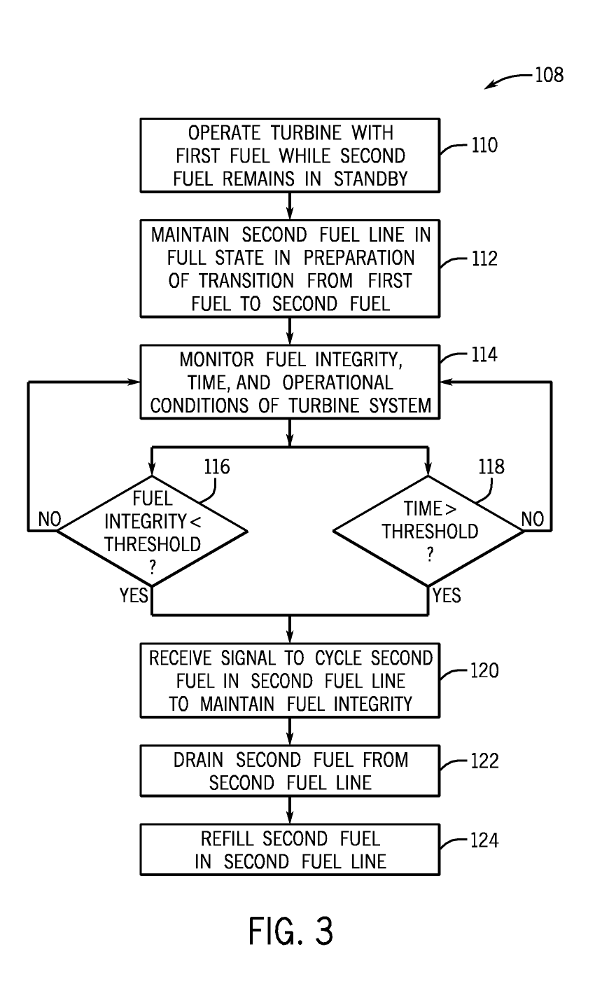

FIGS. 2 and 3 illustrate processes (e.g., computer-implemented processes) to maintain the integrity of the second fuel 30 within the second fuel lines 46, while keeping the liquid fuel 30 available for immediate use by the turbine system 12. Indeed, these processes may be instructions stored on a tangible computer readable medium, e.g., part of a software package. FIG. 2 is a flow chart of an embodiment of a method 80 for filling the second fuel lines 46 within the fuel management system 10. In particular, the process 80 allows for the accelerated filling of the second fuel lines 46 at a variable fuel flow rate in response to a purge of the second fuel lines 46. The turbine fuel controller 14, as described above, implements the process 80 in response to feedback from transducers throughout the fuel management system 10 and the turbine system 12. The process 80 includes operating the turbine system 12 with the first fuel 28 (e.g., gas fuel) while the supply of the second fuel 30 (e.g., liquid fuel) remains available but in standby (block 82). The process 80 may purge the second fuel 30 from the second fuel line 46 to a distance away from the fuel nozzle 16 (block 84). The purging of the second fuel 30 from the line 46 may substantially avoid the heat in the operating region of the turbine system adjacent the turbine fuel nozzle 16 or turbine compartment 15 and maintain the integrity of the second fuel 30 (i.e., avoid coking and/or oxidation). In other words, the second fuel line 46 is purged until the second fuel 30 and purge gas 50 interface is located outside the gas turbine compartment 15. In certain embodiments, the second fuel 30 may be purged from at least 5 meters of the second fuel line 46 adjacent and leading to the second fuel nozzle 16.

Upon receiving a signal to transition from the first fuel 28 to the second fuel 30 (block 86), the transition between fuels 28 and 30 may be delayed until the second fuel line 46 is full (block 88). This delay may be a matter of a few seconds. In response to the signal, the second fuel line 46 is filled with a variable fuel flow rate. In particular, the refill of second full line 46 occurs at a first fuel flow rate (block 90). During this refill, a determination is made (e.g., by the controller 14 in response to feedback from the system 10) whether the percentage of the volume of the second fuel line 46 filled with the second fuel 30 exceeds a first threshold percentage (e.g., 95 percent) of the volume in the second fuel line 46 (block 92). For example, the first threshold percentage may be at least approximately 80, 85, 90, or 95 percent. If the percentage of the volume of the second fuel line 46 filled does not exceed the first threshold percentage, the refill of the second fuel line 46 at the first fuel flow rate continues (block 90). However, if the percentage of the volume of the volume of the second fuel line 46 filled exceeds the first threshold percentage, then the refill of the second fuel line 46 occurs at a second fuel flow rate (block 94). As mentioned above, the second fuel flow rate may be lower than the first fuel flow rate. For example, the second fuel flow rate may be 5, 10, 15 or 20% of the first fuel flow rate.

After the shift to the second fuel flow rate, a determination is made (e.g., by the controller 14 in response to feedback from the system 10) whether the percentage of the volume of the second fuel line 46 filled with the second fuel 30 equals a second threshold percentage of the volume in the second fuel line 46 (block 96). For example, the second threshold percentage may be approximately 100 percent. If the percentage of the volume of the second fuel line 46 filled does not equal the second threshold percentage, the refill of the second fuel line 46 at the second fuel flow rate continues (block 94). However, if the percentage of the volume of the second fuel line 46 filled equals the second threshold percentage, then the transition from the first fuel 28 to the second fuel 30 may occur (block 98). This refill occurs at an accelerated rate allowing the transition to occur in a matter of a few seconds, so the turbine system 12 does not experience any downtime during the transition from the first fuel 28 to the second fuel 30.

FIG. 3 is a flow chart of an embodiment of a process 108 for cycling the second fuel 30 to maintain first fuel integrity (e.g., liquid fuel integrity) within the fuel management system 10. In particular, the process 108 allows for the integrity of the second fuel 30 to be maintained (i.e., avoid coking and/or oxidation), while also keeping a ready supply of the second fuel ready for use by the turbine system 12. The turbine fuel controller 14, as described above, implements the process in response to feedback from transducers throughout the fuel management system 10 and the turbine system 12. The process 108 includes operating the turbine system 12 with the second first fuel 28 (e.g., gas fuel) while the supply of the second fuel 30 (e.g., liquid fuel) remains in standby (block 110). Indeed, the system 10 maintains the second fuel line 46 in a full state with the second fuel 30 in preparation for the transition from the first fuel 28 to the second fuel 30 (block 112).

While maintaining the second fuel lines 46 in the full state, the system 10 (e.g., the turbine fuel controller 14) monitors numerous parameters (block 114). The parameters monitored by the system 10 include fuel integrity (e.g., second fuel integrity), a length of time the second fuel lines 46 have been full with the second fuel 30, and other operational conditions of the turbine system 12. These parameters may be monitored via transducers throughout the fuel management system 10 and/or the turbine system 12. The second fuel integrity may be subject to coking and/or oxidation due to extended periods of time remaining in the second fuel line 46 near the heat from the operating region of the turbine system 12, while the system 12 uses the first fuel 28. As a result, the process 108 includes making inquiries (block 116 and 118) related to the fuel integrity of the second fuel 30. One inquiry 116 includes determining whether the fuel integrity of the second fuel 30, based on acquired feedback, is less than a threshold integrity. If the second fuel integrity remains above or equals the threshold integrity, the system 10 continues to monitor the various parameters mentioned above (block 114). If the fuel integrity is less than the threshold integrity, the system 10 receives a signal to cycle the second fuel 30 in the second fuel line 46 to maintain the second fuel integrity (block 116).

Another inquiry 118 includes determining whether a time (e.g., a time of holding the second fuel 30 in the second fuel lines 46 in a full state) exceeds a threshold time before cycling the second fuel (block 118). For example, the threshold time may be 1, 2, 3, 4, 5, 6, 7, 8, 9, 10, 11, 12, 13, or 14 days, or any other time. In certain embodiments, the time may be reset each time the turbine system 12 transitions between the first and second fuels 28 and 30. If the time remains less than or equals the threshold time, the system 10 continues to monitor the various parameters mentioned above (block 114). If the time exceeds the threshold time, the system receives a signal to cycle the second fuel 30 in the second fuel line 46 to maintain the second fuel integrity (block 120). In response to the signal, draining of the second fuel 30 from the second fuel line 46 occurs as described above (block 122). Following draining the second fuel line 46, the system 10 refills the second fuel 30 in the second fuel line 46. The refilling of the second fuel line 46 may occur as described in process 80. Together the above processes 80 and 108 enable the system 10 to maintain the integrity of the second fuel 30 (e.g., liquid fuel) within the second fuel lines 46 (e.g., liquid fuel lines), while keeping the second fuel available for immediate use by the turbine system 12.

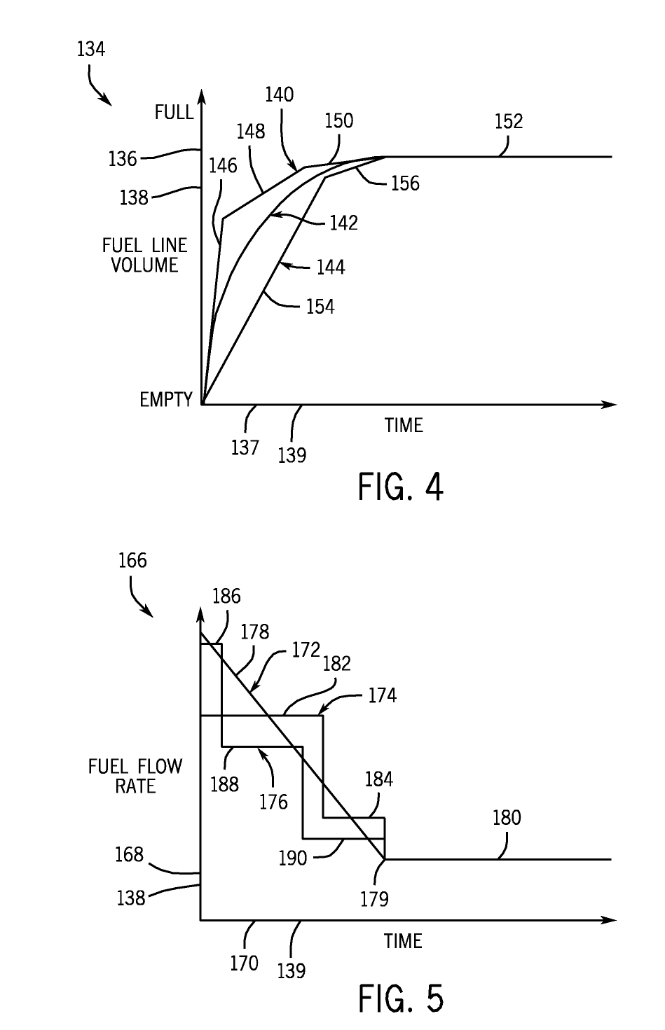

As mentioned above, the variable fuel flow rate employed by the system 10 and the controller 14 may vary. FIG. 4 is a graphical representation 134 of multiple embodiments of variable rates for filling a fuel line volume (e.g., second fuel line 46) with fuel (e.g., second fuel 30) over a period of time. The graph 134 includes a vertical axis 136 representing the fuel line volume of a fuel line (e.g., second fuel line 46). The fuel line volume increases from an empty state to a full state in direction 138 along the axis 136. The graph 134 also includes a horizontal axis 137 representing time. Time increases in a horizontal direction 139 along the axis 137. The graph 134 illustrates three different plots 140, 142, and 144 of the fuel line volume over time. Plots 140 and 144 include the filling of the fuel line volume via a plurality of steps at different fuel flow rates (e.g., slopes). For example, the plot 140 includes a first fuel flow rate, 146, a second fuel flow rate 148, a third fuel flow rate 150, and a fourth fuel flow rate 152. As illustrated, each fuel flow rate 146, 148, 150, and 152 is a constant rate, wherein each successive rate is lower than the preceding rate. As a result the plot 140 depicts a four-stage accelerated fuel fill with a decreasing fuel rate as the fuel line 146 becomes filled with the second fuel 30. For example, the plot 140 may transition between the different fuel flow rates 146, 148, 150, and 152 at different thresholds, such as 75, 90, and 100 percent of a full state of the second fuel line 46. Similarly, the plot 144 depicts a first fuel flow rate 154, a second fuel flow rate 156, and a third fuel flow rate 152. The plot 144 may transition between the different rates 154, 156, and 152 at different thresholds, such as 85 and 100 percent of a full state of the second fuel line 146. In contrast, the plot 142 represents a curvilinear fuel flow rate that gradually decreases as the fuel line becomes filled with the second fuel 30. However, any suitable second fuel flow rate may be used to accelerate the filling of the second fuel line 46.

The differences in the rates of filling the fuel line volume in FIG. 4 is due to variations in the fuel flow rate. FIG. 5 is a graphical representation 166 of multiple embodiments of variable fuel flow rates over a period of time. The graph 166 includes a vertical axis 168 representing the fuel flow rate within a fuel line (e.g., second fuel line 46) with a fuel (e.g., second fuel 30). The fuel flow rate increases in the vertical direction 138 along the axis 168. The graph 166 also includes a horizontal axis 170 representing time. Time increases in the horizontal direction 139 along the axis 170. The graph 166 includes three different plots 172, 174, and 176. All three plots 172, 174, and 176 illustrate variable fuel flow rates. Plot 172 illustrates an initial period (region 178) where the fuel flow rate begins at a higher level and linearly decreases over time until the fuel flow rate reaches a point 179 and shifts to a constant fuel flow rate (region 180). For example, the plot 172 may correspond to the plot 142 of FIG. 4. Plots 174 and 176 illustrate variable fuel flow rates that include a plurality of steps of different constant fuel flow rates. For example, plot 174 includes a higher constant fuel rate (region 182), followed by a lower constant fuel rate (region 184), and then an even lower constant fuel rate (region 180). Plot 174 may correspond to the plot 144 of FIG. 4. Plot 176 includes even more steps of different constant fuel flow rates than plot 174. For example, plot 176 includes a higher constant fuel rate (region 186) followed by progressively lower constant fuel rates (regions 188, 190, and 180, respectively). Plot 176 may correspond to the plot 140 of FIG. 4. The variable fuel flow rates provide various embodiments for the accelerated filling of the fuel line (e.g., second fuel line 46) to allow the fuel management system 10 to maintain the integrity of the second fuel 30 (e.g., liquid fuel) within the second fuel lines 46 (e.g., liquid fuel lines), while keeping the second fuel 30 available for immediate use by the turbine system 12.

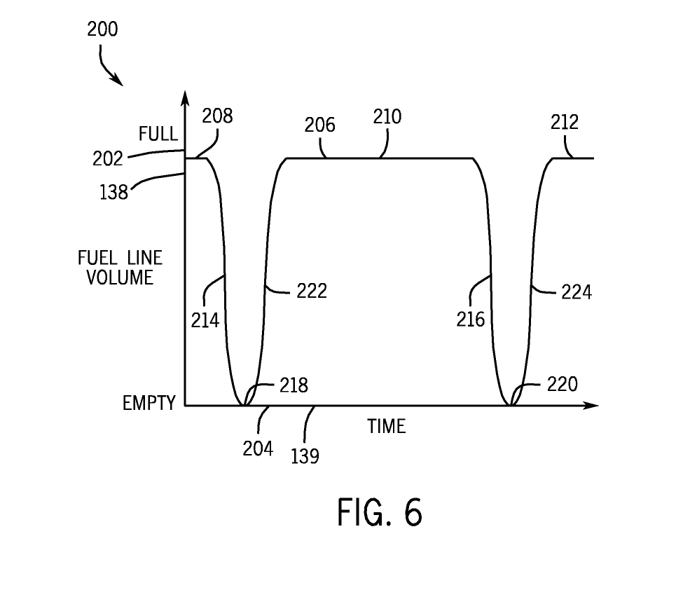

FIG. 6 is a graphical representation 200 of an embodiment of cycling the second fuel 30 within the fuel management system 10 of FIG. 1. In particular, FIG. 6 illustrates the control of the volume of the second fuel 30 (e.g., liquid fuel) in the second fuel line 46 to maintain the second fuel integrity as described in the embodiments above. Also, as described above, the turbine fuel controller 14 controls the cycling of the volume of the second fuel 30 within the second fuel line 46. The graph 200 includes a vertical axis 202 representing the fuel line volume of the fuel line 46 (e.g., first fuel line 46) with fuel (e.g., first fuel 28 such as liquid fuel). The fuel line volume increases from an empty state to a full state in the vertical direction 138 along the axis 202. The graph 200 also includes a horizontal axis 204 representing time. Time increases in the horizontal direction 135 along the axis 204. The graph 200 includes a single plot 206 that illustrates the cyclical purging and refilling of the second fuel line 46 with the second fuel 30. For example, while the turbine system 12 operates with the first fuel 28 (e.g., gas fuel) the second fuel line 46 remains full with the second fuel 30 in standby mode as indicated by regions 208, 210, and 212 of the plot 206. However, occasionally the second fuel 30 is purged from the second fuel line 46 as indicated by regions 214 and 216 until the fuel line volume reaches an empty state indicated at points 218 and 220 of plot 206. The purge of the second fuel 30 from the second fuel line 46 may be in response to a signal indicating a transition from the first fuel 28 to the second fuel 30. Also, as described above, the purge may be due to exceeding the threshold time representing the time the turbine system 12 has continuously operated on the first fuel 28 while the second fuel 30 has remained in the second fuel line 46 in the operating region near the turbine fuel nozzle 16. Further, the purge may be due to the second fuel integrity falling below the first fuel integrity threshold as described above. After the purges, the second fuel line 46 refills as described above (e.g., at an accelerated refill) and indicated by regions 222 and 224 of plot 206. Thus, the turbine fuel controller 14 and the fuel management system 10 may maintain the integrity of the second fuel 30 (e.g., liquid fuel) within the second fuel lines 46 (e.g., liquid fuel lines), while keeping the second fuel 30 available for immediate use by the turbine system 12.

Technical effects of the disclosed embodiments include providing systems with turbine fuel controllers 14 to manage the supply of and transition between fuels (e.g., gas and liquid fuels) to the turbine system 12. The controller 14 includes various logic (e.g., instructions stored on a tangible computer readable medium) to regulate and sequence the purging and refilling of liquid fuel lines to ensure the integrity of liquid fuel (e.g., from coking and/or oxidation), while maintaining a ready supply of the liquid fuel to the turbine system 12. In particular, the controller 14 include logics that enables the cycling of the volume of the liquid fuel in the liquid fuel lines on a periodic basis or when the liquid fuel integrity falls below a particular fuel integrity threshold. In addition, the controller 14 includes logic to enable the accelerated refill of purged liquid fuel lines with liquid fuel. Overall, besides mitigating coking/and or oxidation of the liquid fuel, the controller 14 also provides an automated system that reduces the costs normally associated with both maintenance and avoiding decomposition of the liquid fuel in multi-fuel systems.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a turbine fuel controller configured to control a first supply of a first fuel to a turbine engine, a second supply of a second fuel to the turbine engine, and a transition between the first fuel and the second fuel, wherein the turbine fuel controller comprises a fuel integrity control logic configured to control a volume of the first fuel in a first fuel line to maintain a first fuel integrity while the turbine engine is operating on the second fuel rather than the first fuel.

2. The system of claim 1, wherein the fuel integrity control logic is configured to control the volume of the first fuel in a first portion of the first fuel line in an operating region of the turbine engine leading to a turbine fuel nozzle.

3. The system of claim 2, wherein the first portion comprises at least 5 meters of the first fuel line leading to the turbine fuel nozzle.

4. The system of claim 1, wherein the fuel integrity control logic comprises a fuel replacement cycle logic configured to cycle the volume of the first fuel in the first fuel line by draining the first fuel from the first fuel line and refilling the first fuel line with a replacement supply of the first fuel.

5. The system of claim 4, wherein the fuel replacement cycle logic is configured to cycle the volume of the first fuel after a threshold time of operating the turbine engine.

6. The system of claim 4, wherein the fuel replacement cycle logic is configured to cycle the volume of the first fuel if feedback indicates that the first fuel integrity is less than a threshold integrity.

7. The system of claim 4, wherein the fuel replacement cycle logic is configured to purge the first fuel line with a purge gas to force drainage of the volume of the first fuel from the first fuel line.

8. The system of claim 1, wherein the fuel integrity control logic comprises a variable fuel fill logic configured to fill the volume of the first fuel in the first fuel line with a variable fuel flow rate, the variable fuel flow rate comprises a first fuel flow rate followed by a second fuel flow rate, and the first fuel flow rate is greater than the second fuel flow rate.

9. The system of claim 8, wherein the variable fuel fill logic is configured to fill the first fuel line with the first fuel at the first fuel flow rate until the first fuel fills a first threshold percentage of the volume in the first fuel line, and the variable fuel fill logic is configured to fill the first fuel line with the first fuel at the second fuel flow rate until the first fuel fills a second threshold percentage of the volume in the first fuel line.

10. The system of claim 8, wherein the variable fuel flow rate comprises a plurality of steps of different constant fuel flow rates including the first and second fuel flow rates.

11. The system of claim 8, wherein the variable fuel flow rate comprises a linearly decreasing fuel flow rate.

12. The system of claim 8, wherein the variable fuel flow rate comprises a curvilinear fuel flow rate.

13. The system of claim 1, comprising the turbine engine.

14. A system, comprising:
a turbine fuel controller comprising a fuel integrity control logic configured to maintain a first fuel integrity of a first fuel in a first fuel line while a turbine engine is not operating with the first fuel in the first fuel line, wherein the fuel integrity control logic comprises a fuel replacement cycle logic configured to cycle a volume of the first fuel in the first fuel line by draining the first fuel from the first fuel line and refilling the first fuel line with a replacement supply of the first fuel.

15. The system of claim 14, wherein the fuel replacement cycle logic is configured to cycle the volume of the first fuel after a threshold time of operating the turbine engine.

16. The system of claim 14, wherein the fuel replacement cycle logic is configured to cycle the volume of the first fuel if feedback indicates that the first fuel integrity is less than a threshold integrity.

17. The system of claim 14, wherein the fuel replacement cycle logic is configured to purge the first fuel line with a purge gas to force drainage of the volume of the first fuel from the first fuel line.

18. A system, comprising:
a turbine fuel controller comprising a fuel integrity control logic configured to maintain a first fuel integrity of a first fuel in a first fuel line while a turbine engine is not operating with the first fuel in the first fuel line, wherein the fuel integrity control logic comprises a variable fuel fill logic configured to fill a volume of the first fuel in the first fuel line with a variable fuel flow rate, and the variable fuel flow rate decreases in response to an increase in a percentage fill of the volume of the first fuel line with the first fuel.

19. The system of claim 18, wherein the fuel integrity control logic is configured to control the volume of the first fuel in a first portion of the first fuel line in an operating region of the turbine engine leading to a turbine fuel nozzle, wherein heat in the operating region causes coking and/or oxidation of the volume of the first fuel to decrease the first fuel integrity of the first fuel.

20. The system of claim 19, wherein the fuel integrity control logic is configured to purge the first portion of the first fuel line with a purge gas until a request is received for the first fuel, and the variable fuel fill logic is configured to fill the volume of the first fuel in the first fuel line with the variable fuel flow rate after receipt of the request.
